(19) United States
(12) Patent Application Publication
(10) Pub. No.: US 2026/0230656 A1
(43) Pub. Date: Aug. 6, 2026

(54) DYNAMIC BUFFER MANAGEMENT FOR MEDIA CONTENT

(71) Applicant: Adeia Guides Inc., San Jose, CA (US)

(72) Inventors: Charles Dasher, Lawrenceville, GA (US); Mareeta Mathai, San Jose, CA (US); Tao Chen, Palo Alto, CA (US)

(21) Appl. No.: 19/042,450

(22) Filed: Jan. 31, 2025

(51) Int. Cl. H04N 21/2187; G06F 3/01; G06Q 50/00; H04N 21/442; H04N 21/45; H04N 21/472

(52) U.S. Cl. CPC H04N 21/2187; G06F 3/013; G06Q 10/40; H04N 21/44218; H04N 21/4532; H04N 21/47217

(57) ABSTRACT

The present application provides for dynamic buffer management for media content (e.g., pre-recorded broadcasts, live broadcasts, and/or OTT streaming content), in particular for social media platforms. A content feed server may identify an indication of user interest (e.g., user likes a post about a football play) for media content playing via a content provider service. The content feed server may then monitor the scrolling of the content feed on the user device to identify a key event (e.g., a touchdown) in the media content. The content feed server may then store the data for playing the key event in a memory of the user device (e.g., RAM of the smartphone), and then modify the content feed of the social network platform. The modification causes the user device to display and play a content feed item referencing the key event that was stored in the memory of the user device.

### BACKGROUND

This disclosure is related to systems and methods for playback of media content, and in particular implementing dynamic buffer management for media content playback.

### SUMMARY

Systems that implement social media platforms (e.g., X, formerly Twitter) may have integrated live streaming features, allowing the system to provide media feeds of live events such as sports games, news, or entertainment directly within the social media platform feed. For example, a click on a video embedded in an item feed may play that video directly inside the feed item. However, when user interface input is received to scroll past live video posts, the social media platform feed of the system may be interrupted (e.g., a video may stop playing), requiring manual action to restart the video post. This causes a less intuitive and less engaging interaction with the system implementing the social media platform. Additionally, a system configured to allow users to follow multiple live events simultaneously (e.g., several sports games) cannot effectively manage their viewing experience switching between social media platform posts between multiple live events without manual intervention to restart a video clip. For example, systems may lack features for seamless scrolling between live streams while maintaining the ability to view missed portions or resume the video from real time without manual intervention. Another deficiency of such systems is in the absence of a mechanism to highlight important moments within these live streams, or to ensure that pinned content continues to buffer, while the user engages with other posts of the social media feed on the social media platform. Constantly having to re-buffer the video degrades the system's performance.

In one approach, a system optimizes the number of pre-buffered content feed items based on content quality and user profile data, with, for example, machine learning models predicting whether additional buffering is necessary based on user interface interactions and segment quality. For such systems, the primary goal may be set to balance the quality of experience (QoE) while reducing data wastage, particularly in scenarios where an input to switch from one video to the next is frequently received. However, this approach is deficient in allowing prebuffering for one or more content feed items in a social media feed on the social media platform that does not require manual interaction to commence play of the video-based content feed item. Instead, the aforementioned approach merely prebuffers content feed items based solely on user interface interaction and segment quality.

To help address these problems, systems and methods are provided herein for dynamic buffer management for media content (e.g., pre-recorded broadcasts, live broadcasts, and/or OTT streaming content), such as for social media platforms. In some embodiments, a content feed server may identify an indication of user interest in a media content playing, or available to be played, via a content provider service. For example, the content feed server may determine that a college football game is being played on a secondary device (e.g., smart television) located close to the user's smartphone and that the user interface (UI) input of a user scrolling through their social network feed on XTM on their smartphone includes content feed items related to the college football game. The content feed server may then monitor the scrolling of the content feed on the user device to identify the appropriate time to insert a feed item related to a key event in the media content. Continuing with the example above, the system may detect an indication of a touchdown in the football game via real-time metadata received from the social media network, which is identified as a key event. The content feed server may then cause storing (e.g., buffering or caching) of the data for playing the key event in a memory of the user device (e.g., RAM of the smartphone), and then modify the content feed of the social network platform (e.g., at the next scrolling input). The modification causes the user device to display a content feed item referencing the key event that was stored in the memory of the user device. Continuing with the above example, the content feed server may cause storing of the data for playing the touchdown on the user's smartphone. When the feed is sufficiently scrolled, the content feed server may modify the content feed to insert a new content feed item identifying a video clip of the touchdown. An interaction with the content feed item (e.g., a click or a touch) can then cause the video clip of the touchdown to be played (e.g., inside the content feed item) by the user device using data from the storage.

In some embodiments, the content feed server may identify the indication of user interest through various suitable methods. For example, an indication of interest may be determined based on liking, pinning, saving, bookmarking, forwarding, sharing, posting, or archiving of additional content related to the media content. For example, the system may receive a user input to share a content feed item about the touchdown on their profile on the social network platform that is determined to be an indication of interest. In some embodiments, the content feed server may determine interest by analyzing a user profile associated with the user to identify at least one keyword related to the media content. For example, the content feed server may determine that the user profile mentions the same football team in the feed as the team that is playing in a broadcast on a smart television, proximate to the user's smartphone device. In some other embodiments, an identification of a media device (e.g., smart television playing the game) proximate to the user's smartphone may itself be another indication of interest.

In some embodiments, the content feed server may identify a second key event in the media content, and, based on determining that an eye gaze of the user of the user device was directed at the user device when the second key event was played on the media device, may modify the content feed to include a second content feed item referencing the second key event. For example, if an interception was thrown in the football game, but front-facing cameras on the user's smartphone provides eye gaze data indicating that, at the time of the interception, the user's eye gaze was directed at the smartphone, in essence missing the interception on the media device (e.g., smart television), then the content feed server integrates the interception clip into the content feed such that the viewer can view the interception in the scrolling of the content feed. In other embodiments, the content feed server may identify a third key event in the media content and, based on determining that the eye gaze of the user of the user device was directed at the media device when the third key event was played on the media device, refrain from modifying the content feed to include a third content feed item referencing the third key event. For example, if a field goal is characterized as the third key event, and the user's smartphone provides eye gaze data indicating that, at the time of the field goal, the user's eye gaze was directed towards the smart television, then the content feed server will not insert the content feed item related to the field goal into the content feed for the user. In this scenario, the content feed server instructs deletion of the data for playing the key event stored in the memory of the user device.

In some embodiments, the content feed server may generate a number of user interface options for selection. For example, the content feed server may generate for display a user interface option that may be selected to cause the user device to play the live stream of the media content (e.g., after watching a clip of the football game, there may be an option to watch the game live). In some embodiments, the content feed server may generate a user interface option that may, upon selection, subsequent to the user device playing the key event, cause the user device to play a second key event based on the data for playing the second key event pre-stored in the memory of the user device. This allows for multiple clips (e.g., key events) to be pre-stored (e.g., buffered in RAM or cached in storage) and queued to enhance buffer management. In other embodiments, the playback of the second key event is automatic without user interface selection.

In this way, the presently disclosed systems may be used to effectively manage buffering of media content. The present disclosure introduces a dynamic buffer management system that creates, allocates, and deletes stores (e.g., buffered in RAM or cached in storage) based on the user's scrolling and availability of live-streamed or broadcast content that is found to be of interest. Instead of using solely parameters such as network stability and available bandwidth to determine which content to pre-store, the presently disclosed system implements an additional criterion based on an indication of user interest in media content that is computed against a key event in the media content (e.g., content played on a proximate device). Based on this additional criterion, only relevant media content is stored to maximize network and computing resources within the system servers, user device, and all devices within the aggregate system. This is done particularly when key events occur in longform media content (e.g., a sports event or reality television show) where even if the user is not watching the media content, but has an indication of interest in the media content, the disclosed system pre-stores the key events for ease of viewing at the user's leisure during scrolling of a social media platform. This is enhanced by the system providing a user selection to initiate a live stream subsequent to viewing a pre-stored key event to provide a seamless transition to the media content. Live streams within the user device's content feed receive priority for full storing, while streams that have been selected but are further from the user's indicated interest are allocated time-delayed buffers, where downloads occur in less time-sensitive, background processes. Streams that are deemed of no interest to the user are de-prioritized or paused. This dynamic buffer management conserves resources while ensuring seamless playback when the user returns to live content.

### BRIEF DESCRIPTION OF THE DRAWINGS

The present disclosure, in accordance with one or more various embodiments, is described in detail with reference to the following figures. The drawings are provided for purposes of illustration only and merely depict typical or example embodiments. These drawings are provided to facilitate an understanding of the concepts disclosed herein and should not be considered limiting of the breadth, scope, or applicability of these concepts. It should be noted that for clarity and ease of illustration, these drawings are not necessarily made to scale.

FIG. 1A shows an illustrative scenario in which the content feed server identifies an indication of interest and a key event in a media content to pre-store, in accordance with some embodiments of this disclosure.

FIG. 1B shows an illustrative scenario in which the content feed server inserts a new post relating to the pre-stored key event into the content feed, in accordance with some embodiments of this disclosure.

FIG. 1C shows an illustrative scenario in which the content feed server causes the pre-stored key event to play on the user device, in accordance with some embodiments of this disclosure.

FIG. 2 shows an illustrative scenario in which multiple key events are presented for playback on the user device, in accordance with some embodiments of this disclosure.

FIG. 3 shows an illustrative scenario in which user interface selections are provided for playback of a second key event or live feed subsequent to the first key event, in accordance with some embodiments of this disclosure.

FIG. 4 shows an illustrative scenario in which the content feed server receives a user input selection to play the key event on the user device, in accordance with some embodiments of this disclosure.

FIG. 5 shows an illustrative scenario of key event priority queuing, in accordance with some embodiments of this disclosure.

FIG. 6 is a sequence diagram in which the system receives a user input to select a key event or continue with live stream, in accordance with some embodiments of this disclosure.

FIG. 7 is a sequence diagram in which the system inserts a post into the content feed at a predicted scroll locator, in accordance with some embodiments of this disclosure.

FIG. 8 is a sequence diagram in which the system implements a stacked viewing implementation, in accordance with some embodiments of this disclosure.

FIG. 9 shows illustrative user equipment devices, in accordance with some embodiments of this disclosure.

FIG. 10 shows illustrative systems, in accordance with some embodiments of this disclosure.

FIG. 11 is a flowchart of a detailed illustrative process for the content feed server to modify the content feed, in accordance with some embodiments of this disclosure.

FIG. 12 is a flowchart of a detailed illustrative process for the content feed server to refrain from modifying the content feed to include a third content feed item, in accordance with some embodiments of this disclosure.

### DETAILED DESCRIPTION

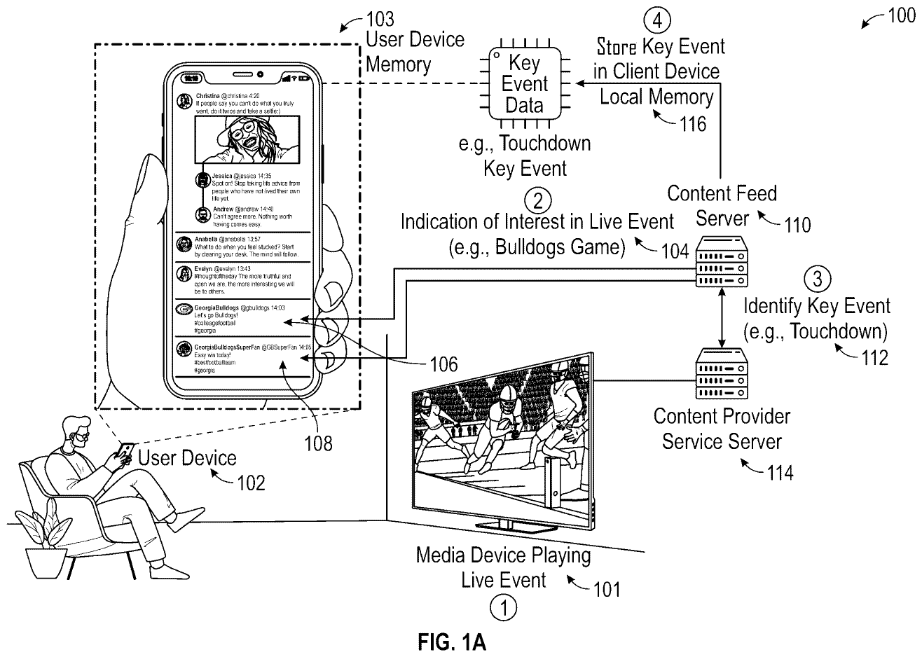

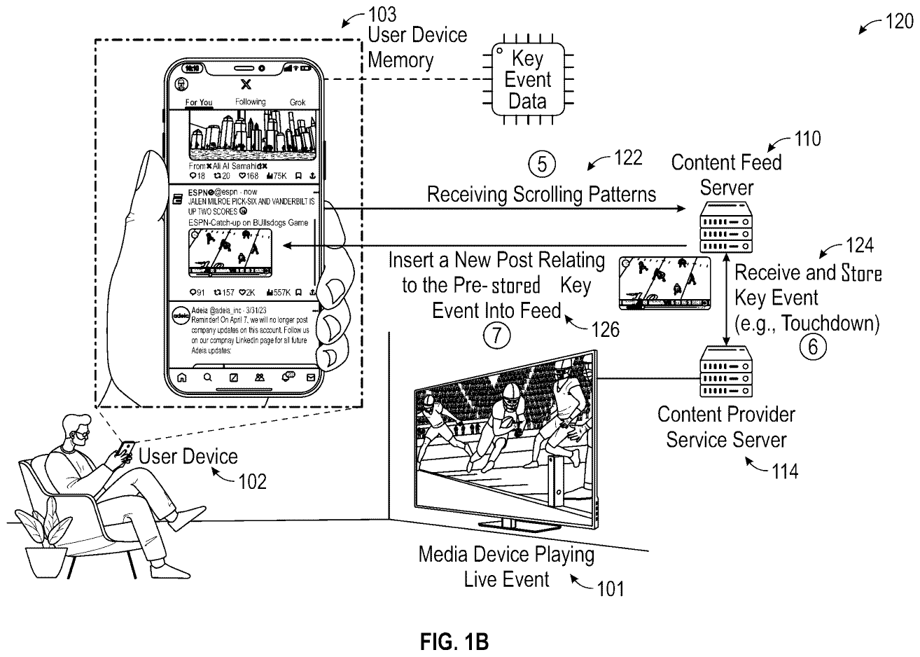

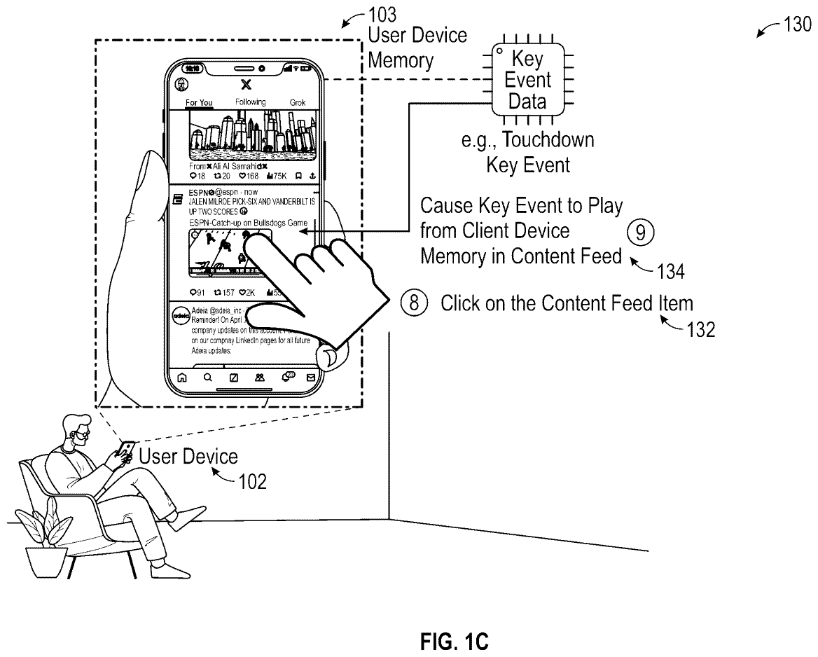

FIG. 1A shows an illustrative scenario 100 in which a content feed server identifies an indication of interest and a key event in a media content item for pre-storing, in accordance with some embodiments of this disclosure. The content feed server may be any suitable device (e.g., one or more servers) that has processing capability and connectivity to a communications network that facilitates the implementation of media content to a social media platform. A social media platform aggregates posts from a plurality of user devices, collates these posts, and creates user profile-specific content feeds based on these posts. The social media platform may select a subset of posts to be inserted into a content feed where the subset may be dependent on user profile preferences, scrolling histories, and similar metadata. The social media platform creates a content feed allowing user devices to interface with the feed to scroll-through control (e.g., vertical scrolling, horizontal scrolling, etc.). The number of content items may be finite or may form an extremely large queue that may seem infinite to the user device (e.g., new posts for the feed may be generated on demand, creating a perception of an infinite feed).

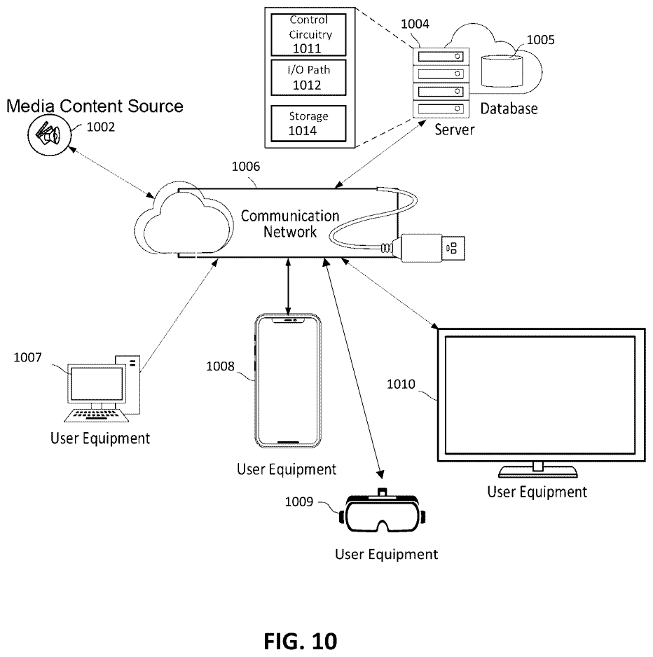

In some embodiments, the content feed server (e.g., server 1014 of FIG. 10) may implement a software application running on a hardware platform. In some embodiments, the content feed server may be implemented via a combination of a server and user device (e.g., server 1014 and/or any of user equipment 1007, 1008, 1009, or 1010). In this example of server/user device, an application may be installed on the user equipment that interfaces with the server 1014 through a communication network 1006. In FIG. 1A, the content feed server 110 interacts with a user device 102 (e.g., smartphone) and a content provider service server 114 (e.g., an OTT streaming platform). The content provider service server is playing a live event 101 (e.g., football game involving the Georgia Bulldogs). The content feed server may identify an indication of user interest in a media content playing via a content provider service. Returning to FIG. 1A, the content feed server 110 identifies an indication of user interest by determining a post within the feed relates to the Georgia Bulldogs college football team seen at both 106 and 108. While some steps of FIG. 1 are described as performed by the content feed server 110, one skilled in the art would appreciate that some such suitable steps may be performed by the content feed server 110, an application (e.g., social media application) executing on user device 102, or on combination of content feed server 110 and user device 102 (e.g., when a social media app has client/server distributed functionality).

User interest may be identified in various ways. In some embodiments, the content feed server 110 may identify an indication of user interest by determining that at least one of the following actions in relation to media content has been selected by a user of the social media platform: liking, pinning, saving, bookmarking, forwarding, sharing, posting, or archiving. For example, the content feed server may determine an indication of user interest by determining that the user, with the UI of user device 102, has liked a content feed item related to the Georgia Bulldogs football team. In another example, the content feed server 110 may determine an indication of user interest by determining the user device 102 has forwarded a content feed item related to the Georgia Bulldogs football team to a user profile on the social media network. In other embodiments, the content feed server 110 may identify an indication of user interest by analyzing a user profile associated with the user to identify at least one keyword related to the media content. In some embodiments, the analysis of the user profile may be performed by the content feed server 110 and/or the user device 102. Returning to the example in FIG. 1A, the content feed associated with the user profile included posts related to the Georgia Bulldogs college football team that is related to the Georgia Bulldogs football game being displayed by media device 101 (and being broadcast by content provider service server 114). In some embodiments, the media may be available via live stream (e.g., OTT, IPTV, or other similar media streaming services).

In other embodiments, the content feed server 110 may identify an indication of user interest by determining that the media content is being generated for display on a media device located in proximity to the user device. As shown in FIG. 1A, the smartphone 102 is proximate to the smart television 101 as they are within the same room. The threshold of proximity may be preconfigured or determined by the content feed server 110 based on a determination of locational information of both devices. Locational information may be shared by the user device (e.g., smartphone), and/or the media device (e.g., television). Locational information may be any combination of locational telemetry such as networking signals triangulation, Bluetooth beacons, GPS, near field communications (NFC), and locational sensors. In some embodiments, the user device 102 may receive audio data from the media device 101 (e.g., the smartphone can hear football game audio from the smart television and determine a level of proximity based on audio signal volume).

The content feed server may monitor scrolling of a content feed on a user device 102 associated with a user. For example, the content feed server 110 may interface with a software application installed on the user device 102 to capture scrolling data including scrolling speed, number of pauses, amount of time per scrolling session, total amount of scrolling sessions within a day, and other scrolling metrics. The content feed server may receive metadata from an application for the social media platform to determine scrolling activity of a content feed, such as information related to scrolling speed, content feed location data, content feed items that garnered the most interaction (e.g., pausing on content feed item, sharing of content feed item, etc.), temporal data of scrolling patterns of the user device, scrolls per session, and other related metrics inclusive of scrolling. For example, in FIG. 1A, the content feed server 110 may receive data through a software application installed on the user device 102 indicating that the content feed items relating to the Georgia Bulldogs at 106 and 108 were paused or remained on-screen for a threshold period of time during scrolling by the user device 102.

The content feed server may identify a key event in the media content. For example, in FIG. 1A, as the media content is a Georgia Bulldogs football game, the content provider service server 114 may provide metadata for this game that includes a subset of metadata defining what constitutes key events (e.g., touchdowns, interceptions, safety, field goals, injury, half-time, full-time, and/or overtime). The content feed server 110 identifies at 112 a key event (e.g., touchdown) in the football game received from the content provider service server 114. In some embodiments, the content feed server 110 includes a mechanism for detecting key events in live streams. The content feed server may implement this through metadata from the live stream provider or through real-time analytics (such as crowd reactions or significant spikes in activity). When a key event is detected, the content feed server 110 automatically stores and repositions the relevant live stream post within the content feed. Upon scrolling to the post containing the key event in the content feed, the playback allows the user to immediately watch significant moments without missing important context without delay, due to the pre-storing of the key event. In scenarios where the content feed server 110 receives data from the software application that indicates that the user is engaged with a content feed item associated with another live stream or other social media activities, the content feed server may generate for display a user notification of key events of the media content.

The content feed server may, based at least in part on the identifying the key event in the media content, store data for playing the key event in a memory of the user device. In FIG. 1A, at 116, the content feed server 110 stores the touchdown video data in the smartphone memory 103 (e.g., acquired from content provider server 114). For example, the content feed server 110 may send an instruction to the application on the user device 102 to store the touchdown key event in the smartphone memory (e.g., by accessing a network location, for example from a manifest) from content provider server 114). In another embodiment, data to be stored may be made available by content provider server 114 to the content feed server 110, in which case the user device 102 may access the data to be stored directly from content feed server 110. In some embodiments, the memory of the user device 102 may include random access memory, cache, CPU memory, GPU memory, any other memory suitable for storing, and/or a combination of the same. The content feed server 110 may then modify the default content feed to a modified content feed. The default feed may be a plurality of content feed items curated by the content feed server 110 to be displayed on the user device 102 via a software application. The modified content feed may be the default content feed modified by the content feed server 110 to display a content feed item referencing the key event within the content feed. In particular, the content feed server 110 causes the user device 102 to display a content feed item referencing the key event. FIG. 1B shows an illustrative scenario 120 in which the content feed server 110 inserts a new post relating to the prestored key event into the content feed, in accordance with some embodiments of this disclosure. The content feed server 110 receives the scrolling patterns 122 and has stored the key event (e.g., touchdown) into the smartphone memory 103 at 124. The content feed server 110 then inserts (e.g., via a software application installed on the user device) a new content feed item (e.g., post) into the content feed at 126 relating to the touchdown. The content feed server 110 may modify the content feed item, allowing the user device 102 to display the video clip of the touchdown within its content feed as the video content is prestored and plays smoothly from the local storage in user device memory 103 without interruption, providing a more immersive experience. Without the content feed server 110 modifying the content feed, the default feed would remain in place without the content feed item containing the prestored key event for user selection. The term “content feed item” refers to data that is generated by the content feed server 110 for display on a content feed for a user of a social networking or other media platform. The content feed item may be a post, a tweet, a message, a listing, a page, an image, a voice note, a videoclip, and/or any other multimedia item that may be generated for display on the social media platform.

In some embodiments, based on a user interface interaction with the content feed item, the content feed server 110 causes the user device 102 to play the key event based on the data for playing the key event stored in the memory of the user device. For example, the content feed server 110 provides an instruction to be transmitted through a software application in the user device 102 to play an MPEG-4 video file that is saved within the user device memory 103 location 0x7ffd5e8e1e4. FIG. 1C shows an illustrative scenario 130 in which the content feed server 110 causes the prestored key event to play on the user device 102, in accordance with some embodiments of this disclosure. In FIG. 1C, the content feed server receives a user interface input where, at 132, the user clicks on the content feed item for the touchdown. In response to the selected user interface input, the content feed server 110 causes the touchdown video clip to play from the user device memory 103 in the content feed at 134.

In some embodiments, the content feed server 110 may identify a second key event in the media content. Based on determining that an eye gaze of the user of the user device was directed towards the user device 102 when the second key event was played on the media device 101, the content feed server 110 modifies the content feed on the user device to include a second content feed item referencing the second key event. In specific examples where there is a media device and a user device (e.g., a two-screen scenario), the eye gaze may be received by the content feed server 110 via optical sensors from the user device (e.g., front-facing cameras that monitor a user's eye gaze) through the software application installed on the user device. For example, if the user was preoccupied with scrolling on their smartphone during a key event in the football game (e.g., an interception), and the eye gaze data at the time of the interception provides that the user had their eye gaze directed at the smartphone instead of the smart television, it may be assumed that the user missed the interception key event. The content feed server may then modify the content feed to include this content feed item (e.g., interception) for the user to view. In other embodiments, the content feed server 110 may identify a third key event in the media content, and, based on determining that eye gaze of the user of the user device 102 was directed to the media device 101 when the third key event was played on the media device, the content feed server 110 refrains from modifying the content feed to include a third content feed item referencing the third key event. In contrast to the previous example, if the user is viewing the smart television for a third key event (e.g., a field goal), then, although the field goal is determined as a key event, because the eye gaze data at the time of the field goal provides that the user's eye gaze was directed to the smart television, the content feed is not modified with a content feed item referencing the field goal. In some embodiments, there may be multiple key events related to a long-form sports event (e.g., a football game). In such a scenario, the content feed server 110 may provide a plurality of key events that are prestored and associated with the modified content feed (e.g., the plurality of key events are inserted into the content feed based on scrolling) such that a user can follow along with the game by just scrolling through the key event content feed items.

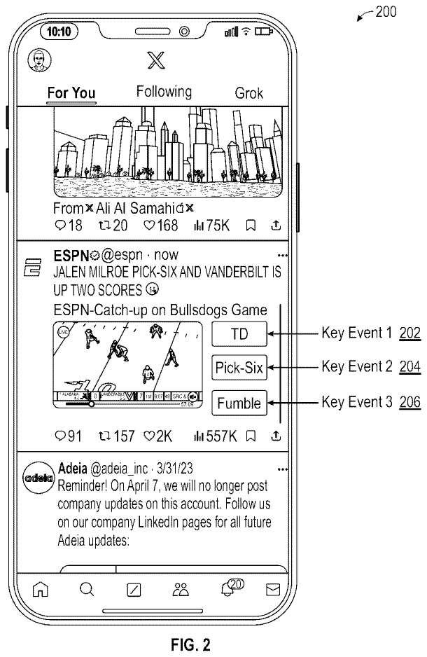

FIG. 2 shows an illustrative scenario 200 in which multiple key events are presented for play on the user device (e.g., user device 102 of FIG. 1), in accordance with some embodiments of this disclosure. In this example, the content feed item includes multiple selections, unlike a conventional content feed item. The first key event indicates a touchdown button selection that is currently being generated for display in the video window beside the button 202. The second key event is a pick-six 204, and a third key event is a fumble 206. Both the second key event and the third key event are prestored for subsequent viewing. Moreover, FIG. 2 may be an example of a user having previously “subscribed” to a live stream of a football game (e.g., by interacting with a special interface provided by a social media application for insertion of feed items from a live event). In this example, the content feed server (e.g., content feed server 110 of FIG. 1) receives user input, via a software application running the social networking platform on the user device, that the user has subscribed to a user profile on the social networking platform providing the live stream of the media event. The content feed server may receive data from the software application that the user has scrolled past the content feed item that is displaying the live stream and is now scrolling through other posts. Upon a key event occurring, the content feed item may modify the content feed to insert the key event for display into the user's content feed. The stored media shows a navigation scrubber (not shown) indicating that the user interface selection may time-shift the content (e.g., a user interface selection such as a toolbar, fast-forward/rewind icons, or similar navigation mechanisms). The play position is set to the point where the key event occurred within the media content. In other embodiments, the content feed server may store a segment of the media content (e.g., five minutes of the football game) which has corresponding timestamps for each of the multiple key events (e.g., key event 1 at 1:34, and key event 2 at 2:45, and key event 3 at 4:30). As the entire five-minute segment is prestored, the content feed server can provide it for immediate playback upon received selection of the key event.

In some embodiments, the content feed server may, subsequent to the user device playing the first key event, generate for display a user interface comprising an option to generate for display a live stream of the media content. In some embodiments, the content feed server may receive a user input that causes the user device to play the live stream of the media content. In other embodiments, the content feed server may automatically play the live stream of the media content after completion of the display of the key event. In yet other embodiments, the content feed server may, while the content feed item referencing the first key event is displayed, identify a second key event in the media content and store data for playing the second key event in the memory of the user device. Immediately after the user device plays the key event, the content feed server may cause (e.g., send instruction to) the user device to play the second key event based on the data for playing the second key event stored in the memory of the user device.

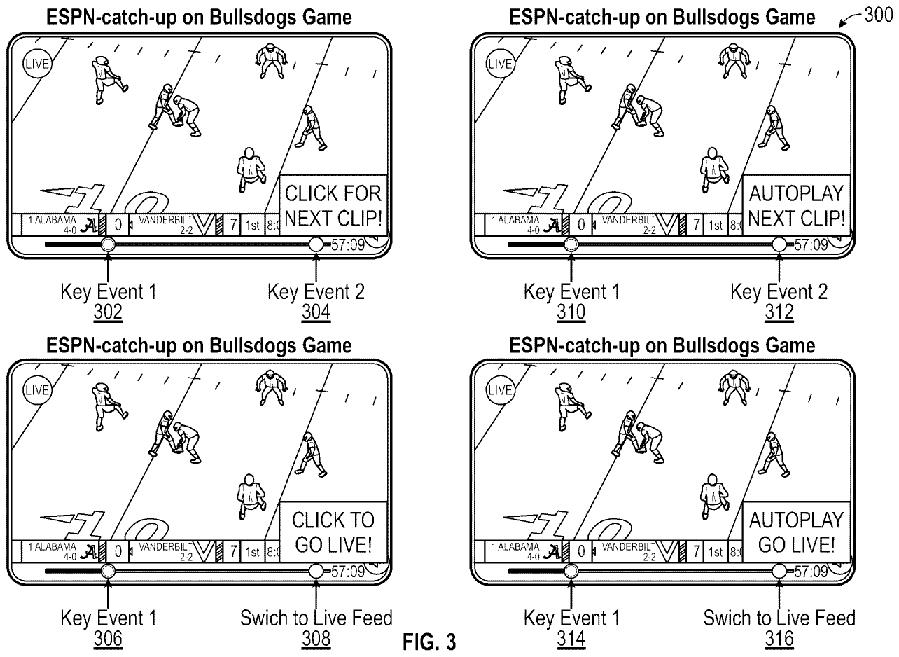

FIG. 3 shows an illustrative scenario 300 in which user interface of a user device (e.g., user device 102 of FIG. 1) provides selections for playback of a second key event or live feed subsequent to the first key event, in accordance with some embodiments of this disclosure. In this figure there are four examples of video playback interfaces. At 302, the key event 1 is being played with key event 2 prestored and ready to play upon a user interface click at 304. Key event 1 is prestored prior to the key event even being displayed within the content feed as described above. In particular, the content feed server (e.g., content feed server 110 of FIG. 1) pre-stores key event 1 upon identifying key event 1 (e.g., 30-yard gain occurs in the football game). In other variants, at 310, the key event 1 is being played with key event 2 prestored and ready to play immediately subsequent to the completion of the playback of key event 1 without any required user interface interaction at 312. At 306, the key event 1 is being played with a live feed of the media content prestored and ready to play upon a user interface click at 308. In other variants, at 314, the key event 1 is being played with a live feed of the media content prestored and ready to play immediately subsequent to the completion of the playback of key event 1 without any required user interface interaction at 316. In some embodiments, the content feed server may initiate a live stream of a live event upon a user interface selection during the playback of a key event. In this example, if the user wishes to skip the key event to join the live event immediately, selection may be received via a user interface (e.g., touch screen input) to generate for display the live stream. In other embodiments, the content feed server may initiative a live stream of a live event prior to generating for display the key events. For example, if the user is watching a football game in overtime, the user may wish to watch the game uninterrupted in overtime prior to selecting for display the key events to catchup on the key events in the game.

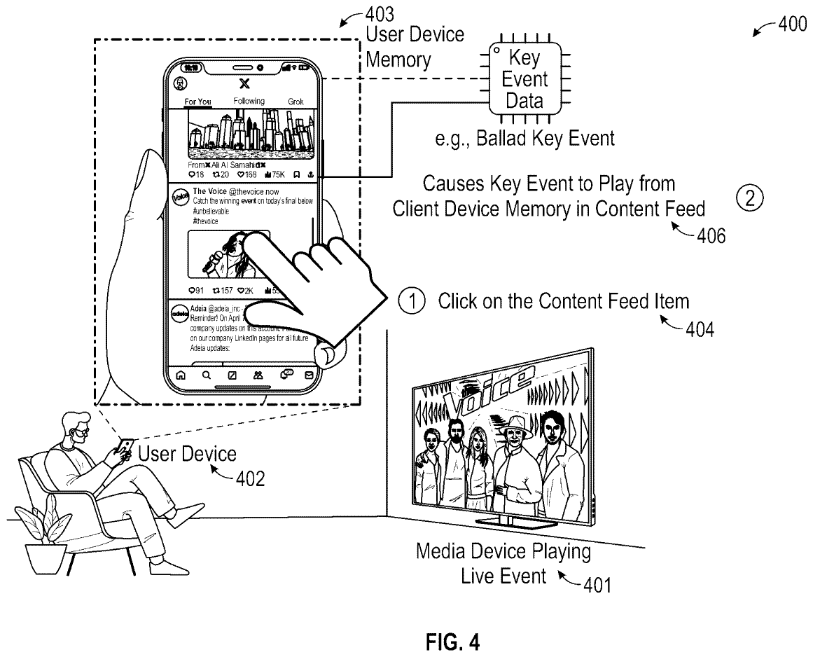

FIG. 4 shows an illustrative scenario 400 in which the content feed server (e.g., content feed server 110 of FIG. 1) receives a user input selection via a user device (e.g., user device 102 of FIG. 1) to play the key event on the user device 402, in accordance with some embodiments of this disclosure. In this example, at 401, the media content being played is the reality television show “The Voice,” which is a live broadcast television show that may be viewed via the content feed server interacting with the media content service server. The content feed server receives a user interface selection at 404 on the user device 402. This causes the key event, which may be the winning performance of a contestant on “The Voice,” to play from the smartphone memory 403. In some embodiments, the media content playing via the content provider service server comprises at least one of pre-recorded broadcast content, live broadcast content, and/or streaming content.

In some embodiments, the content feed server may identify a second key event in the media content while the content feed item referencing the first key event is displayed, and store data for playing the second key event in the memory of the user device. Subsequent to the user device playing the first key event, the content feed server may generate for display a user interface comprising an option to generate for display the second key event. The user interface selection of the option causes the user device to play the second key event based on the data for playing the second key event stored in the memory of the user device. If multiple key events have been detected from a same live stream and are to be presented, the notification of the multiple key events can be sorted based on measurable significance. For instance, an astounding action that ends a tie-break may be measured and ranked more highly in the set than a mid-game scoring action. Thus, even if the key event in the tie-break occurred later in the game, it may be presented and listed in the notification as the top key event. This is useful when the space allocated for notification is limited, and the listing of key events can then be dynamically shuffled as new key events are detected. This differs from presenting events or segments in a linear manner along the timeline as is a common practice in DVR or time-shifted viewing.

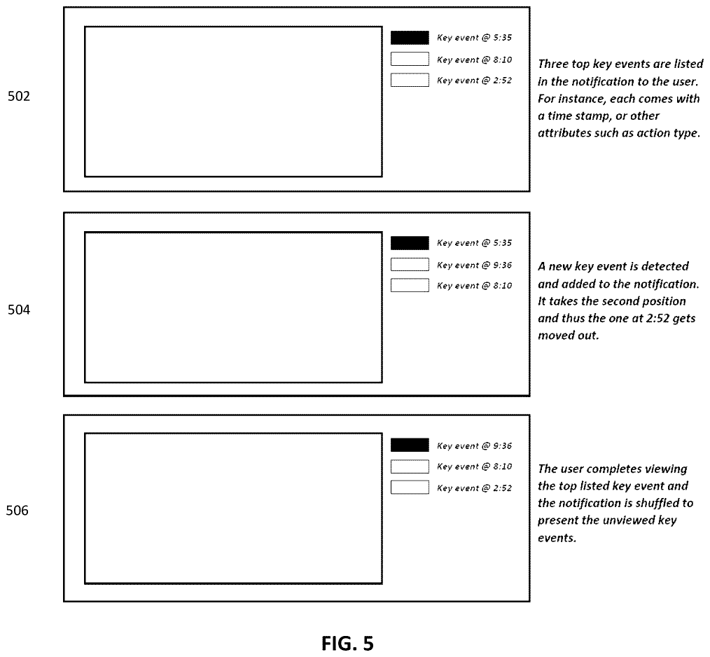

FIG. 5 shows an illustrative scenario 500 of key event priority queuing, in accordance with some embodiments of this disclosure. At 502, the user interface of a user device (e.g., user device 102 of FIG. 1) displays three key events and their respective timestamps within the media content. Moreover, these key events are ordered (e.g., by content feed server 110 of FIG. 1) in a queue from highest priority at the top to lowest priority at the bottom. Three top key events are listed in the notification to the user, and each comes with a timestamp and/or other attributes such as action type. At 504, a new key event is detected (e.g., similar to FIG. 1A at 112) and added to the notification. It takes the second position, and thus the key event with timestamp at 2:52 gets relegated out of the queue. At 506, the user completes viewing of the top-listed key event, and the notification is shuffled to present the unviewed key events (e.g., the key event with timestamp at 2:52, which was previously unviewed). In some embodiments, while the content feed item referencing the first key event is displayed (e.g., similar to FIG. 1B at 126), the content feed server may identify a second key event in the media content and store data for playing the second key event in the memory of the user device. Subsequent to the user device playing the first key event (e.g., similar to FIG. 1C at 134), the content feed server generates for display a user interface comprising an option to generate for display the second key event. In response to a determination that the option for generating for display the second key event was not selected, the content feed server may delete the data for playing the second key event stored in the memory of the user device. In an alternative embodiment of FIG. 5, the key event with timestamp 2:52 may be deleted and the pre-stored data will also be deleted from local memory 103.

In some embodiments, the nonlinearity in sorting and presenting the key events can be extended to the aggregate notification in case of multiple live streams. The detected key events can be listed in the notification and transmitted by the content feed server to a user device via the software application and shuffled over time when more significant key events occur. When user interface selection is received for a particular key event, the content feed server modifies the content feed to generate for display the key event on the user device (e.g., similar to FIG. 1C at 134). In some embodiments, where a user interface is received indicating the user scrolls away from a live stream and later scrolls back, the content feed server may play back the live streaming session with key events in a seamless manner. For example, at the time the user interface input is received that the user is scrolling back to the live stream, if there is no key event occurring (or what happens in the live session is not of interest, e.g., an ad break), the content feed server may generate for display on the user device the top-ranked key event from this live stream. If the current live session presents a key event (or an event that is detected as a key event), the content feed server may generate for display the live session on the user device. In this case, the currently playing key event is deemed viewed by the user, and the content feed server no longer adds this key event to the notification.

In some embodiments, the content feed server, upon identifying an indication of user interest, may determine the level of interest. The level of interest may be a gross estimation of high, medium, and low (e.g., based on metadata). In other variants, a confidence score may be determined based on a number of factors such as metadata of the user's profile and/or other data related to the user and/or user device. Based on the determined level of interest, multiple actions may be taken. For high interest, the content feed server may implement the modification to the content feed as described in the above embodiments (e.g., in relation to FIGS. 1A-1C). For medium interest, the content feed server may implement buffer stored data for playing the key event in a memory of the user device on a time delay. The time delay may be predetermined, and/or based on available network resources. For low interest, the content feed server may not modify the content feed at all. When user input is received tagging multiple live streams, the content feed server prioritizes storage allocation based on user-defined preferences or preset criteria (such as stream popularity or importance of key events). A user interface selection may be received by the content feed server that toggles between different streams, and the content feed server ensures that stored content is available for each tagged stream, providing a seamless multi-stream viewing experience.

In some embodiments, if the user is not actively scrolling when the key event occurs, the content feed server will continue storing the segment in the background. The stored content remains available until either another key event is detected or a predefined period of time elapses without further events. When the user resumes scrolling, the content feed server places the live stream post back into their feed, allowing the user to either continue with the real-time stream or view selectable indicators of the previously detected key events. These indicators allow for the content feed server to receive user interface selection by the user to choose whether to view the significant moments they missed or continue watching the live stream uninterrupted.

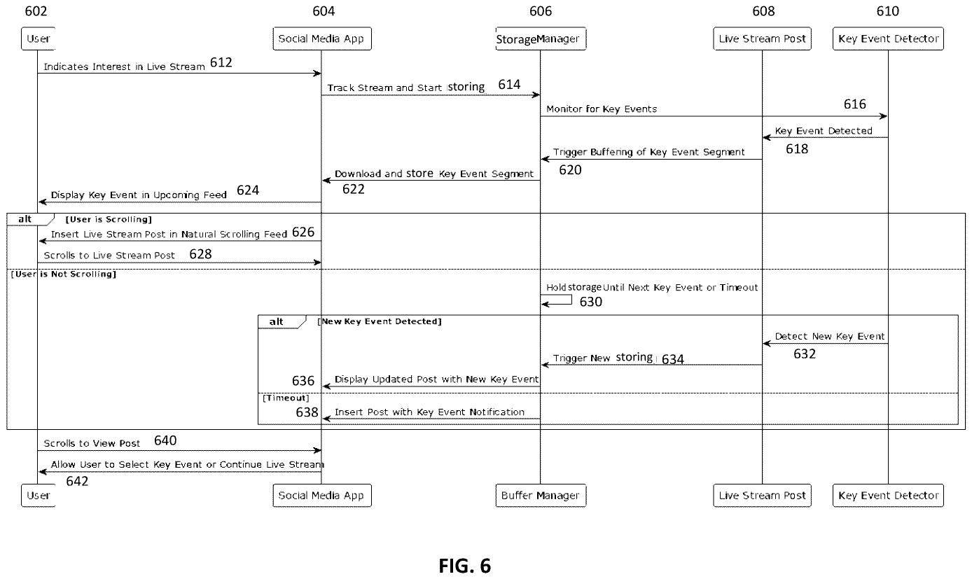

FIG. 6 shows a sequence diagram 600 in which the system receives a user interface input to select a key event or continue with live stream, in accordance with some embodiments of this disclosure. The sequence diagram includes a user 602 (e.g., this may be implemented as a user interface in communication with the content feed server) of a user device (e.g., user device 102 of FIG. 1), a social media application 604, a storage manager (or, in the figure, “buffer manager”) 606 (e.g., a content feed server 110 of FIG. 1), a live stream post 608, and key event detector 610. At 612, the social media application 604 receives an indication of interest in a live stream from the user (e.g., similar to FIG. 1A at 104) and tracks the stream and starts storing (or, in the figure, “buffering”) the stream at 614. At 616, the storage manager monitors the stream for key events via the key events detector 610 (e.g., the content feed server that may be server 1004 of FIG. 10). Communication of the key event being detected 618 by the key event detector is sent to the live stream post 608 (e.g., via a software application installed on user equipment such as 1007, 1008, 1009, and 1010 of FIG. 10). At 620, the storage manager receives the trigger to store the key event segment and, at 622, downloads and stores the key event segment to the social media app 604 (e.g., similar to FIG. 1A at 116). At 624, the user device receives a display of the key event in the upcoming modified content feed from the content feed server. If the content feed server receives a scrolling input of the user, the social media application inserts (e.g., similar to FIG. 1B at 126) the live stream post naturally into the content feed at 626, where the user will naturally scroll to the live stream post 628. If the content feed server receives an input that the user is not scrolling, the storage manager holds the storage until the next key event or timeout at 630. A new key event may be detected at the live stream post 632, which triggers new storing of the new key event 634 at the storage manager. At 636, the storage manager then transmits an instruction (e.g., via the content feed server) to generate for display the updated post on the user device with new key event and, at 638, inserts the post with key event notification. A UI input indicating the user may scroll to view the post at 640 and optionally select the key event or continue to the livestream at 642 (as shown in FIG. 3) may be received by the content feed server.

In some embodiments, the content feed server may pre-store media content that is selected as priority (e.g., pinned on the content feed by the user). This may enable the content feed server to receive UI inputs from user devices to tag live events for continuous storing even when the content feed navigates away from the media content. The UI input may tag or pin live-streamed posts, marking them for indefinite storage persistence. For tagged posts, the content feed server continues to allocate storage space and download live content, regardless of the user's current position in the feed. This allows the user to return to pinned content and either watch missed portions of the stream or skip forward to the real-time broadcast. The storing of these posts occurs in the background, so the user's interaction with other parts of the platform is uninterrupted.

In some embodiments, the content feed server enhances the live-stream viewing experience by dynamically adjusting the playback position based on real-time analysis of social media posts related to the live content. The content feed server monitors user-generated posts, comments, and interactions within the social media platform, detecting spikes in activity that correspond to significant events in the live-streamed content. For example, if a large number of users are posting about a recent touchdown during a football game, the content feed server analyzes the timing and context of these posts to identify the precise moment in the live stream when the touchdown occurred. To achieve this, the content feed server integrates a real-time social sentiment and activity analysis engine that continuously collects data from user interactions, such as likes, comments, shares, and posts. Using natural language processing (NLP) and event clustering algorithms, the system identifies keywords, phrases, and patterns that indicate significant events, such as “goal,” “touchdown,” “score,” or “breaking news.” The engine correlates this social activity with the live stream's timeline, creating an index of key moments within the live event. Once the content feed server determines that a key event has occurred, it adjusts the playback point for users who are currently watching the live stream or returning to the post. When the UI input indicates that a user scrolls to the post or re-engages with the content, the content feed server automatically sets the playback point to the beginning of the detected key event (e.g., the moment when the touchdown occurred). This allows the user to view the highlighted event immediately, ensuring that important moments are not missed, even if they were previously watching or browsing other content. The content feed server can also provide visual markers or timeline highlights within the live-stream interface, allowing for UI input on user devices to manually navigate to other detected key events during playback. These markers indicate moments that have been identified as significant based on the real-time social activity surrounding the events. For example, a visual indicator may be displayed on the timeline corresponding to other key moments in the game, such as touchdowns, interceptions, or major plays, and UI selection of these points may be made to instantly jump to them. In some embodiments, if the screen size is too small to accommodate the multiple key events' indicators, the content feed server may implement a new feature in the player button that generates a user interface showing a tabular version of the key events' timestamps. It allows for UI input to click and seek the respective timestamps.

In some embodiments, to ensure the accuracy of the key event detection, the content feed server implements temporal filtering to avoid false positives and irrelevant content. It analyzes the frequency and density of related posts over time, ensuring that only sustained social activity triggers an adjustment of the playhead (e.g., a playhead displays a frame in the media content at any given position of the timeline of the media content). Additionally, the content feed server may cross-reference multiple sources, such as posts from verified users or prominent figures, to validate the importance of the event. In some embodiments, where a user is following several live events simultaneously, the content feed server prioritizes key events across all live streams the user has tagged or is following, placing the most significant events higher in the content feed or closer to the visual gaze of the user within the content feed. The content feed server ensures that, for each live event, the UI selections are provided such that selection can be made to either view the live stream in real time or immediately jump back to the last significant event based on aggregated social media activity.

In some embodiments, the content feed server adopts adaptive/offline storing in case of network constraints. Depending on the operating system and network capabilities, the content feed server may continue to download data of tagged streams. If poor network conditions are anticipated, storing of multiple tagged live streams may be paused after a predefined amount of initial data has been downloaded, or data may be downloaded at a lower quality. A threshold on the downloading time can also be increased or decreased depending on the network conditions.

In some embodiments, when a live stream is shared as a post on a social media platform, the content feed server may identify the live stream as “followable,” meaning it includes key events that can be detected and tracked for subsequent notification to user devices. The content feed server may receive a user indication of their interest in the live stream by their interactions with the post, such as selecting or pinning it, and choosing their preferences for viewing. These preferences may allow the post to be resurfaced when a key event occurs or opt for other modes of viewing such as modes based on stacked key events or time period(s) (e.g., such as half-time).

In some embodiments, the content feed server continuously monitors the live stream for key events, and the user device (which is running the social media application) simultaneously tracks the user's scrolling behavior. This behavior includes parameters like scroll speed, direction, and current location within the social media feed. This behavior also includes details on what portion(s) of a selected live stream(s) has been viewed. The client (e.g., software application) periodically transmits this data to the content feed server, enabling the content feed server to assess the user's current position (e.g., via received UI inputs of the user device via the software application), predict their future scrolling behavior, and determine which key events to push to the user device. When the content feed server detects a key event in the live stream that is not viewed by the user, it notifies the user device. The user device performs a manifest fetch, which includes metadata associated with the key event. The client downloads the first (or first n) segments and upon completion, and based on the user's current scroll speed, places the resurfaced post/media content into the user's feed at a point in the feed where the user is likely to encounter it as they continue scrolling.

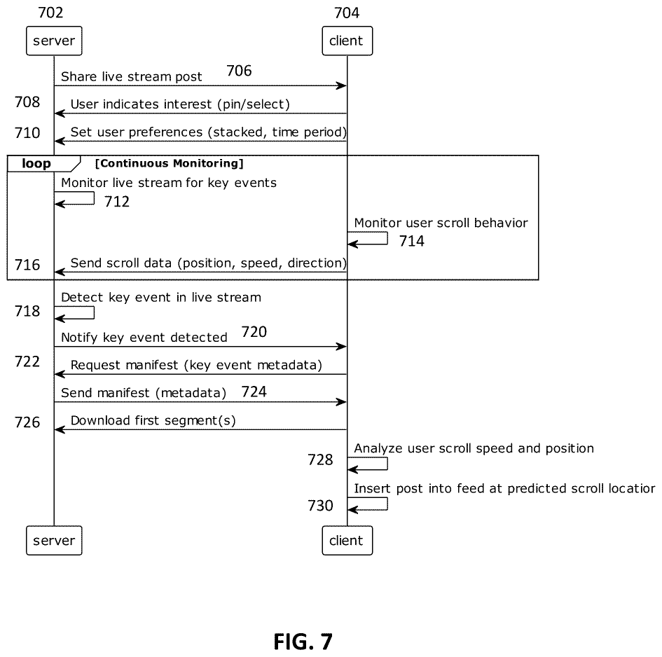

FIG. 7 shows a sequence diagram 700 in which the system inserts a post into the content feed at a predicted scroll locator, in accordance with some embodiments of this disclosure. The sequence diagram includes a server (e.g., content feed server 110 of FIG. 1) 702 and a user device (or, in the figure “client”) 704 (e.g. user device 102 of FIG. 1). The server may share a live stream post with the user interface at 706 and receives an indication of interest 708 and user preferences (e.g., time period) 710. The server may then implement continuous monitoring of the live stream for key events 712 and receives scroll data 716 from the monitored user scroll behavior 714. The server may then detect a key event in the live stream at 718 and notifies the user device of the key event 720. The server may then receive a requested manifest 722 that includes key event metadata and send this manifest to the user device 724. The server may then download the first segment 726. The user device may continue to analyze user scroll 728 and insert the post into the feed at the predicted scroll locator 730 (e.g., similar to FIG. 1B at 126).

In some embodiments, when the content feed server receives UI selection that the user opts for stacked viewing, the content feed server accumulates key event segments over a predefined number of events or within a set time interval. During this period, the content feed server manages the download and storing of the segments using an adaptive bitrate (ABR) streaming approach, ensuring that the segments are fetched at the highest feasible quality based on network conditions. To ensure consistent playback, the content feed server dynamically adjusts the ABR across all segments in the stack. (Since ABR streaming allows for quality variations depending on bandwidth availability, the content feed server monitors the quality levels of each segment as they are downloaded.) In some embodiments, if the segments are downloaded at different quality levels due to fluctuating network conditions, the content feed server normalizes the quality by either re-downloading lower-quality segments at a higher bitrate or selecting a uniform quality level that all segments can support without storing interruptions. In other embodiments, if there are fluctuating network conditions, the content feed server downloads the segments at a predefined quality level (e.g., 4K, 1080p, or 720p resolutions). Once either the conditions for stacked playback are met or the user-defined number of key events has accumulated, the user device presents the stored key event segments immediately sequentially. If the timecodes between segments are significantly off, the content feed server may compensate by treating each segment independently, stitching them together based on the order in which they are downloaded or detected. In other embodiments, the content feed server could re-encode the segments to normalize them. The content feed server could extract the media content and recompress it with consistent, sequential timecodes, essentially flattening the segments into a continuous timeline. In yet other embodiments, the content feed server may generate new timecodes that follow a simple, sequential order, treating each segment as if it begins immediately after the previous one. To prevent abrupt transitions between segments, the content feed server may implement crossfades or similar transitions that may help mask any discrepancies in timing.

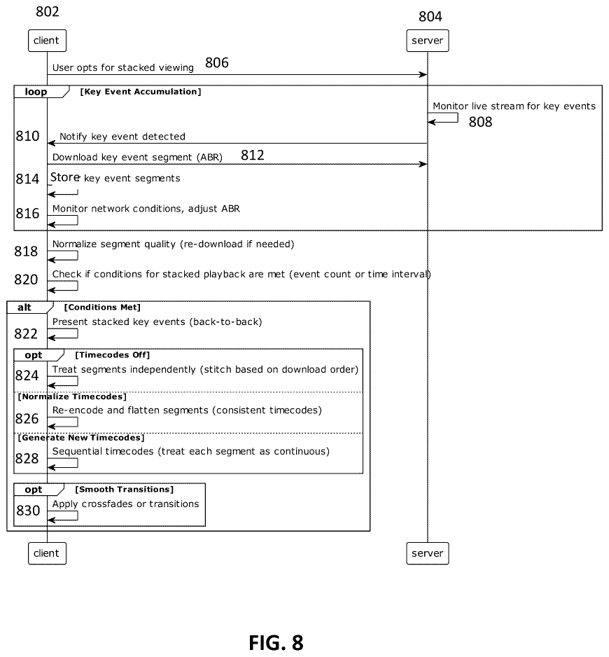

FIG. 8 shows a sequence diagram 800 in which the system implements a stacked viewing implementation, in accordance with some embodiments of this disclosure. The sequence diagram includes a client 802 (e.g., user device 102 of FIG. 1) and a server (e.g., content feed server 110 of FIG. 1) 804. The server receives IU input notification that the user opts for stacked viewing 806 and monitors the live stream for key events 808. Upon a key event being detected 810, the key event segment is downloaded implementing ABR 812. The user device stores (or in the figure, “buffers”) the key event segments 814, monitors network conditions to adjust ABR 816, normalizes segment quality 818, and determines if conditions for stacked playback are met (e.g., via event count and/or time interval) 820. If the conditions are met, the user device presents the stacked key events sequentially 822. If the timecodes are varied based on the above processes, the user device may treat segments independently (e.g., stitch them together based on download order) 824, normalize timecodes by reencoding and flattening video segments 826, and generate new sequential timecodes 828. If smooth transitions are implemented, the user device may apply crossfades or other transitions 830.

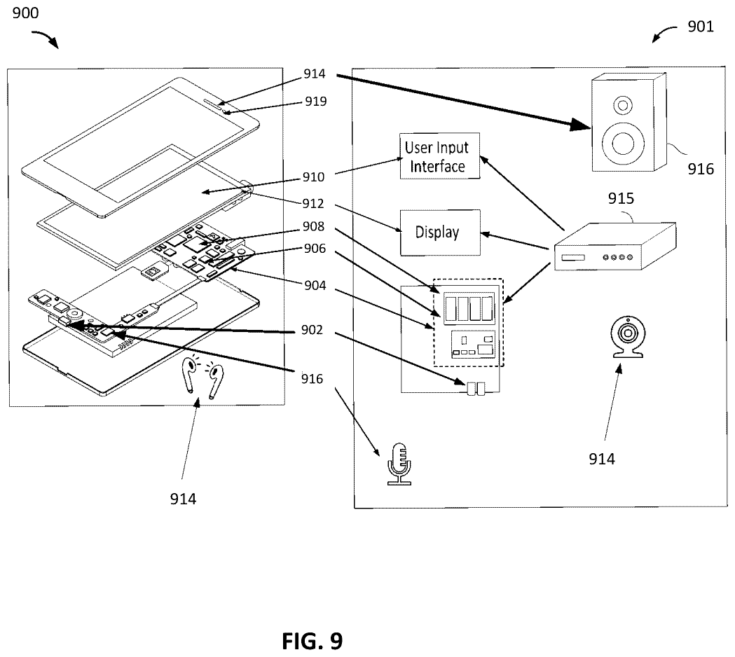

FIGS. 9-10 describe illustrative devices, systems, servers, and related hardware for a media application for efficient navigation of a plurality of media assets and for playing post-credit content in media assets by overriding play-next logic, in accordance with some embodiments of this disclosure. FIG. 9 shows generalized embodiments of illustrative user devices 900 and 901. For example, user equipment device 900 may be a smartphone device, a tablet, smart glasses, a virtual reality or augmented reality device (e.g., AR goggles, AR headset, AR implemented via smartphone, tablet, or computer), or any other suitable device capable of consuming media assets and capable of transmitting and receiving data over a communication network. In another example, user equipment device 901 may be a user television equipment system or device. User television equipment device 901 may include set-top box 915. Set-top box 915 may be communicatively connected to microphone 916, audio output equipment (e.g., speaker or headphones 914), and display 912. In some embodiments, microphone 916 may receive audio corresponding to a voice of a user, e.g., a voice command. In some embodiments, display 912 may be a television display or a computer display. In some embodiments, set-top box 915 may be communicatively connected to user input interface 910. In some embodiments, user input interface 910 may be a remote control device. Set-top box 915 may include one or more circuit boards. In some embodiments, the circuit boards may include control circuitry, processing circuitry, and storage (e.g., RAM, ROM, hard disk, removable disk, etc.). In some embodiments, the circuit boards may include an input/output path. More specific implementations of user equipment devices are discussed below in connection with FIG. 10. In some embodiments, device 900 may comprise any suitable number of sensors, as well as a GPS module (e.g., in communication with one or more servers and/or cell towers and/or satellites) to ascertain a location of device 900.

Each one of user equipment device 900 and user equipment device 901 may receive content and data via input/output (I/O) path 902. I/O path 902 may provide content (e.g., broadcast programming, on-demand programming, Internet content, content available over a local area network (LAN) or wide area network (WAN), and/or other content) and data to control circuitry 904, which may comprise processing circuitry 906 and storage 908. Control circuitry 904 may be used to send and receive commands, requests, and other suitable data using I/O path 902, which may comprise I/O circuitry. I/O path 902 may connect control circuitry 904 (and specifically processing circuitry 906) to one or more communications paths (described below). I/O functions may be provided by one or more of these communications paths, but are shown as a single path in FIG. 10 to avoid overcomplicating the drawing. While set-top box 915 is shown in FIG. 10 for illustration, any suitable computing device having processing circuitry, control circuitry, and storage may be used in accordance with the present disclosure. For example, set-top box 915 may be replaced by, or complemented by, a personal computer (e.g., a notebook, a laptop, a desktop), a smartphone (e.g., device 900), a tablet, a network-based server hosting a user-accessible user device, a non-user-owned device, any other suitable device, or any combination thereof.

Control circuitry 904 may be based on any suitable control circuitry such as processing circuitry 906. As referred to herein, control circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, control circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 904 executes instructions for the Media application stored in memory (e.g., storage 908). Specifically, control circuitry 904 may be instructed by the Media application to perform the functions discussed above and below. In some implementations, processing or actions performed by control circuitry 904 may be based on instructions received from the Media application.

In client/server-based embodiments, control circuitry 904 may include communications circuitry suitable for communicating with a server or other networks or servers. The media application may be a stand-alone application implemented on a device or a server. The media application may be implemented as software or a set of executable instructions. The instructions for performing any of the embodiments discussed herein of the media application may be encoded on non-transitory computer-readable media (e.g., a hard drive, random-access memory on a DRAM integrated circuit, read-only memory on a BLU-RAY disk, etc.). For example, in FIG. 10, the instructions may be stored in storage 908 and executed by control circuitry 904 of a device 900.

In some embodiments, the media application may be a client/server application where only the client application resides on device 900, and a server application resides on an external server (e.g., server 1004). For example, the media application may be implemented partially as a client application on control circuitry 904 of device 900 and partially on server 1004 as a server application running on control circuitry 1011. Server 1004 may be a part of a local area network with one or more of devices 900 or may be part of a cloud computing environment accessed via the internet. In a cloud computing environment, various types of computing services for performing searches on the internet or informational databases, providing storage (e.g., for a database 1005) or parsing data are provided by a collection of network-accessible computing and storage resources (e.g., server 1004), referred to as “the cloud.” Device 900 may be a cloud client that relies on the cloud computing capabilities from server 1004 to determine whether processing should be offloaded and facilitate such offloading. When executed by control circuitry 904 or 1011, the media application may instruct control circuitry 904 or 1011 circuitry to perform processing tasks for the user device and facilitate a media consumption session integrated with social network services. The client application may instruct control circuitry 904 to determine whether processing should be offloaded.

Control circuitry 904 may include communications circuitry suitable for communicating with a server, social network service, a table or database server, or other networks or servers. The instructions for carrying out the above-mentioned functionality may be stored on a server (which is described in more detail in connection with FIG. 10). Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communication networks or paths (which is described in more detail in connection with FIG. 10). In addition, communications circuitry may include circuitry that enables peer-to-peer communication of user equipment devices, or communication of user equipment devices in locations remote from each other (described in more detail below).

Memory may be an electronic storage device provided as storage 908 that is part of control circuitry 904. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 908 may be used to store various types of content described herein as well as media application data described above. Nonvolatile memory may also be used (e.g., to launch a boot-up routine and other instructions). Cloud-based storage may be used to supplement storage 908 or instead of storage 908.

Control circuitry 904 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 904 may also include scaler circuitry for upconverting and down converting content into the preferred output format of user equipment 900. Control circuitry 904 may also include digital-to-analog converter circuitry and analog-to-digital converter circuitry for converting between digital and analog signals. The tuning and encoding circuitry may be used by user equipment device 900, 901 to receive and to display, to play, or to record content. The tuning and encoding circuitry may also be used to receive media consumption data. The circuitry described herein, including for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 908 is provided as a separate device from user equipment device 900, the tuning and encoding circuitry (including multiple tuners) may be associated with storage 908.

Control circuitry 904 may receive instruction from a user by way of user input interface 910. User input interface 910 may be any suitable user interface, such as a remote control, mouse, trackball, keypad, keyboard, touch screen, touchpad, stylus input, joystick, voice recognition interface, or other user input interfaces. Display 912 may be provided as a stand-alone device or integrated with other elements of each one of user equipment device 900 and user equipment device 901. For example, display 912 may be a touchscreen or touch-sensitive display. In such circumstances, user input interface 910 may be integrated with or combined with display 912. In some embodiments, user input interface 910 includes a remote-control device having one or more microphones, buttons, keypads, any other components configured to receive user input or combinations thereof. For example, user input interface 910 may include a handheld remote-control device having an alphanumeric keypad and option buttons. In a further example, user input interface 910 may include a handheld remote-control device having a microphone and control circuitry configured to receive and identify voice commands and transmit information to set-top box 915.

Audio output equipment 914 may be integrated with or combined with display 912. Display 912 may be one or more of a monitor, a television, a liquid crystal display (LCD) for a mobile device, amorphous silicon display, low-temperature polysilicon display, electronic ink display, electrophoretic display, active matrix display, electro-wetting display, electro-fluidic display, cathode ray tube display, light-emitting diode display, electroluminescent display, plasma display panel, high-performance addressing display, thin-film transistor display, organic light-emitting diode display, surface-conduction electron-emitter display (SED), laser television, carbon nanotubes, quantum dot display, interferometric modulator display, or any other suitable equipment for displaying visual images. A video card or graphics card may generate the output to the display 912. Audio output equipment 914 may be provided as integrated with other elements of each one of device 900 and equipment 901 or may be stand-alone units. An audio component of videos and other content displayed on display 912 may be played through speakers (or headphones) of audio output equipment 914. In some embodiments, audio may be distributed to a receiver (not shown), which processes and outputs the audio via speakers of audio output equipment 914. In some embodiments, for example, control circuitry 904 is configured to provide audio cues to a user, or other audio feedback to a user, using speakers of audio output equipment 914. There may be a separate microphone 916 or audio output equipment 914 may include a microphone configured to receive audio input such as voice commands or speech. For example, a user may speak letters or words that are received by the microphone and converted to text by control circuitry 904. In a further example, a user may voice commands that are received by a microphone and recognized by control circuitry 904. Camera 918 may be any suitable video camera integrated with the equipment or externally connected. Camera 918 may be a digital camera comprising a charge-coupled device (CCD) and/or a complementary metal-oxide semiconductor (CMOS) image sensor. Camera 918 may be an analog camera that converts to digital images via a video card.

The media application may be implemented using any suitable architecture. For example, it may be a stand-alone application wholly-implemented on each one of user equipment device 900 and user equipment device 901. In such an approach, instructions of the application may be stored locally (e.g., in storage 908), and data for use by the application is downloaded on a periodic basis (e.g., from an out-of-band feed, from an Internet resource, or using another suitable approach). Control circuitry 904 may retrieve instructions of the application from storage 908 and process the instructions to provide media consumption and social network interaction functionality and generate any of the displays discussed herein. Based on the processed instructions, control circuitry 904 may determine what action to perform when input is received from user input interface 910. For example, movement of a cursor on a display up/down may be indicated by the processed instructions when user input interface 910 indicates that an up/down button was selected. An application and/or any instructions for performing any of the embodiments discussed herein may be encoded on computer-readable media. Computer-readable media includes any media capable of storing data. The computer-readable media may be non-transitory including, but not limited to, volatile and non-volatile computer memory or storage devices such as a hard disk, floppy disk, USB drive, DVD, CD, media card, register memory, processor cache, Random Access Memory (RAM), etc.

Control circuitry 904 may allow a user to provide user profile information or may automatically compile user profile information. For example, control circuitry 904 may access and monitor network data, video data, audio data, processing data, participation data from a media application and social network profile. Control circuitry 904 may obtain all or part of other user profiles that are related to a particular user (e.g., via social media networks), and/or obtain information about the user from other sources that control circuitry 904 may access. As a result, a user can be provided with a unified experience across the user's different devices.

In some embodiments, the media application is a client/server-based application. Data for use by a thick or thin client implemented on each one of user equipment device 900 and user equipment device 901 may be retrieved on-demand by issuing requests to a server remote to each one of user equipment device 900 and user equipment device 901. For example, the remote server may store the instructions for the application in a storage device. The remote server may process the stored instructions using circuitry (e.g., control circuitry 904) and generate the displays discussed above and below. The user device may receive the displays generated by the remote server and may display the content of the displays locally on device 900. This way, the processing of the instructions is performed remotely by the server while the resulting displays (e.g., that may include text, a keyboard, or other visuals) are provided locally on device 900. Device 900 may receive inputs from the user via input interface 910 and transmit those inputs to the remote server for processing and generating the corresponding displays. For example, device 900 may transmit a communication to the remote server indicating that an up/down button was selected via input interface 910. The remote server may process instructions in accordance with that input and generate a display of the application corresponding to the input (e.g., a display that moves a cursor up/down). The generated display may then be transmitted to device 900 for presentation to the user.

In some embodiments, the media application may be downloaded and interpreted or otherwise run by an interpreter or virtual machine (run by control circuitry 904). In some embodiments, the media application may be encoded in the ETV Binary Interchange Format (EBIF), received by control circuitry 904 as part of a suitable feed, and interpreted by a user agent running on control circuitry 904. For example, the media application may be an EBIF application. In some embodiments, the media application may be defined by a series of JAVA-based files that are received and run by a local virtual machine or other suitable middleware executed by control circuitry 904. In some of such embodiments (e.g., those employing MPEG-2 or other digital media encoding schemes), the media application may be, for example, encoded and transmitted in an MPEG-2 object carousel with the MPEG audio and video packets of a program.

FIG. 10 is a diagram of an illustrative system 1000, in accordance with some embodiments of this disclosure. User equipment devices 1007, 1008, 1009, 1010 (e.g., user device 102 of FIG. 1; devices or any other suitable devices, or any combination thereof) may be coupled to communication network 1006. Communication network 1006 may be one or more networks including the Internet, a mobile phone network, mobile voice or data network (e.g., a 5G, 4G, or LTE network, or any other suitable network or any combination thereof), cable network, public switched telephone network, or other types of communication network or combinations of communication networks. Paths (e.g., depicted as arrows connecting the respective devices to the communication network 1006) may separately or together include one or more communications paths, such as a satellite path, a fiber-optic path, a cable path, a path that supports Internet communications (e.g., IPTV), free-space connections (e.g., for broadcast or other wireless signals), or any other suitable wired or wireless communications path or combination of such paths. Communications with the user devices may be provided by one or more of these communications paths but are shown as a single path in FIG. 10 to avoid overcomplicating the drawing.

Although communications paths are not drawn between user equipment devices, these devices may communicate directly with each other via communications paths as well as other short-range, point-to-point communications paths, such as USB cables, IEEE 1394 cables, wireless paths (e.g., Bluetooth, infrared, IEEE 1002-11x, etc.), or other short-range communication via wired or wireless paths. The user equipment devices may also communicate with each other directly through an indirect path via communication network 1006.

System 1000 may comprise media content source 1002, one or more servers 1004, and one or more social network services. In some embodiments, the media application may be executed at one or more of control circuitry 1011 of server 1004 (and/or control circuitry of user equipment devices 1007, 1008, 1009, 1010. This is similar to FIG. 1 wherein the content feed server 110 may be implemented as server 1004 and Content Provider Service Server 114 may be implemented as media content source 1002.

In some embodiments, server 1004 may include control circuitry 1011 and storage 1014 (e.g., RAM, ROM, Hard Disk, Removable Disk, etc.). Instructions for the media application may be stored in storage 1014. In some embodiments, the media application, via control circuitry, may execute functions outlined in FIGS. 1-5. Storage 1014 may store one or more databases. Server 1004 may also include an input/output path 1012. I/O path 1012 may provide media consumption data, social media data, device information, or other data, over a local area network (LAN) or wide area network (WAN), and/or other content and data to control circuitry 1011, which may include processing circuitry, and storage 1014. Control circuitry 1011 may be used to send and receive commands, requests, and other suitable data using I/O path 1012, which may comprise I/O circuitry. I/O path 1012 may connect control circuitry 1011 (and specifically control circuitry) to one or more communications paths. I/O path 1012 may comprise I/O circuitry.

Control circuitry 1011 may be based on any suitable control circuitry such as one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, control circuitry 1011 may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 1011 executes instructions for an emulation system application stored in memory (e.g., the storage 1014). Memory may be an electronic storage device provided as storage 1014 that is part of control circuitry 1011.

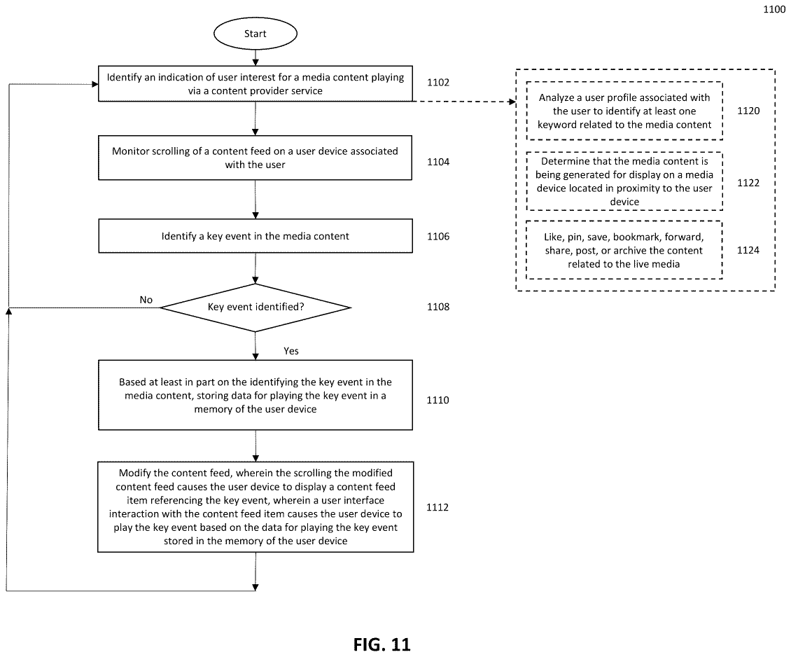

FIG. 11 is a flowchart of a detailed illustrative process for the content feed server to modify the content feed, in accordance with some embodiments of this disclosure. In various embodiments, the individual steps of process 1100 may be implemented by one or more components of the devices and systems of FIGS. 1-10, e.g., content feed server 110 of FIG. 1 and user device 102 of FIG. 1. Although the present disclosure may describe certain steps of process 1100 (and of other processes described herein) as being implemented by certain components of the devices and systems of FIGS. 1-10, this is for purposes of illustration only, and it should be understood that other components of the devices and systems of FIGS. 1-10 may implement those steps instead.

At 1102, the content feed server, via a control circuitry (e.g., control circuitry 1011 of FIG. 10), identifies an indication of user interest in a media content item playing via a content provider service. The indication of user interest may be identified via an I/O path (e.g., I/O path 1012) over a communication network (e.g., communication network 1006). The content provider service may be a media content source (e.g., media content source 1002). Optionally, at 1102, the content feed server, via a control circuitry, may identify an indication of user interest by analyzing a user profile associated with the user to identify at least one keyword related to the media content at 1120. Optionally, at 1102, the content feed server, via a control circuitry, may identify an indication of user interest by determining that the media content is being generated for display on a media device located in proximity to the user device at 1122. Optionally, at 1102, the content feed server, via a control circuitry, may identify an indication of user interest by determining at least one of a like, pin, save, bookmark, forward, share, post, or archiving of the content related to the live media at 1124.

At 1104, the content feed server, via a control circuitry, monitors scrolling of a content feed on a user device associated with the user. The user device may be a user equipment (e.g., at least one of user equipment 1007, 1008, 1009, or 1010).

At 1106, the content feed server, via a control circuitry, determines an identification of a key event in the media content. If, at 1108, the content feed server has not determined the identification of the key event, the process reverts to 1102. If, at 1108, the media server has determined the identification of the key event, the process advances to 1110. At 1110, the content feed server, based at least in part on the identifying the key event in the media content, stores data for playing the key event in a memory of the user device. The memory of the user device may be storage (e.g., storage 1014), or local memory on the user device.

At 1112, the content feed server, via a control circuitry, modifies the content feed, wherein the scrolling the modified content feed causes the user device to display a content feed item referencing the key event. A user interface interaction with the content feed item causes the user device to play the key event based on the data for playing the key event stored in the memory of the user device.

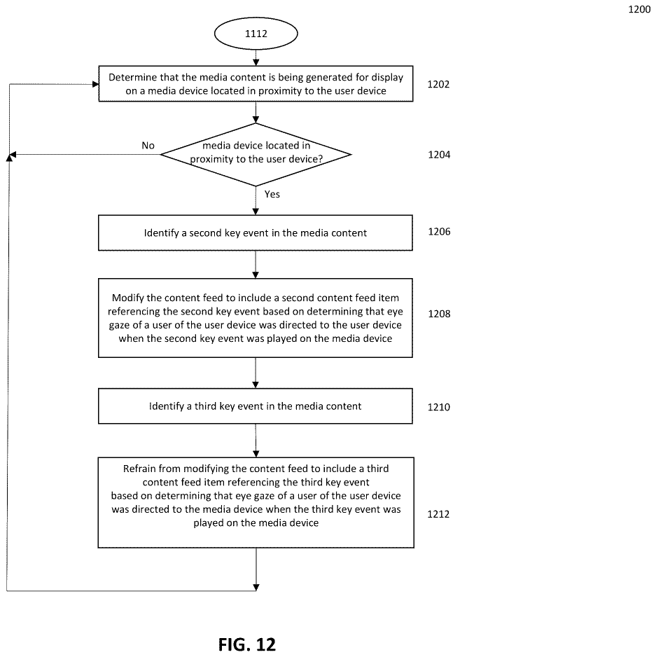

FIG. 12 is a flowchart of a detailed illustrative process 1200 for the content feed server to refrain from modifying the content feed to include a third content feed item, in accordance with some embodiments of this disclosure. At 1202, the content feed server, via a control circuitry, determines that the media content is being generated for display on a media device located in proximity to the user device. The media device may be a user equipment (e.g., at least one of user equipment 1007, 1008, 1009, or 1010), e.g., content feed server 110 of FIG. 1 and user device 102 of FIG. 1. The control circuitry determines that the media content being generated for display on a media device may be implemented via an I/O path (e.g., I/O path 1012) over a communication network (e.g., communication network 1006). If, at 1204, the content feed server determines the media device is not located in proximity to the user device, the process reverts to 1202. If, at 1204, the content feed server determines the media device is located in proximity to the user device, the process continues to 1206. At 1206, the content feed server, via a control circuitry, identifies a second key event in the media content.

At 1208, the content feed server, via a control circuitry, modifies the content feed to include a second content feed item referencing the second key event based on determining that eye gaze of a user of the user device was directed to the user device when the second key event was played on the media device.

At 1210, the content feed server, via a control circuitry, identifies a third key event in the media content. At 1212, the content feed server, via a control circuitry, refrains from modifying the content feed to include a third content feed item referencing the third key event based on determining that eye gaze of a user of the user device was directed to the media device when the third key event was played on the media device.

The processes discussed above are intended to be illustrative and not limiting. One skilled in the art would appreciate that the steps of the processes discussed herein may be omitted, modified, combined and/or rearranged, and any additional steps may be performed without departing from the scope of the disclosure. More generally, the above disclosure is meant to be illustrative and not limiting. Only the claims that follow are meant to set bounds as to what the present disclosure includes. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

1. A method comprising:
identifying an indication of user interest of a user for a media content playing via a content provider service;
monitoring scrolling of a content feed on a user device associated with the user;
identifying a key event in the media content;
based at least in part on the identifying the key event in the media content:
storing data for playing the key event in a memory of the user device; and
modifying the content feed, wherein the scrolling of the modified content feed causes the user device to display a content feed item referencing the key event, wherein a user interface interaction with the content feed item causes the user device to play the key event based on the data for playing the key event stored in the memory of the user device.

2. The method of claim 1, wherein the identifying the indication of user interest in the media content comprises at least one of: liking, pinning, saving, bookmarking, forwarding, sharing, posting, or archiving of additional content related to the media content.

3. The method of claim 1, wherein the identifying the indication of user interest in the media content comprises analyzing a user profile associated with the user to identify at least one keyword related to the media content.

4. The method of claim 1, wherein the identifying the indication of user interest in the media content comprises determining that the media content is being generated for display on a media device located in proximity to the user device.

5. The method of claim 4, wherein the key event is a first event, and the content feed item is a first content feed item, and the method further comprises:
identifying a second key event in the media content;
based on determining that eye gaze of the user of the user device was directed to the user device when the second key event was played on the media device, modifying the content feed on the user device to include a second content feed item referencing the second key event;
identifying a third key event in the media content; and
based on determining that eye gaze of the user of the user device was directed to the media device when the third key event was played on the media device, refraining from modifying the content feed to include a third content feed item referencing the third key event.

6. The method of claim 1, further comprising:
subsequent to the user device playing the key event, generating for display a user interface comprising an option to generate for display a live stream of the media content, wherein a user interface interaction with the option causes the user device to play the live stream of the media content.

7. The method of claim 1, wherein the key event is a first key event, further comprising:
while the content feed item referencing the first key event is displayed:
identifying a second key event in the media content; and
storing data for playing the second key event in the memory of the user device; and
subsequent to the user device playing the first key event, generating for display a user interface comprising an option to generate for display the second key event, wherein a user interface interaction with the option causes the user device to play the second key event based on the data for playing the second key event stored in the memory of the user device.

8. The method of claim 1, wherein the key event is a first key event, the method further comprising:
while the content feed item referencing the first key event is displayed:
identifying a second key event in the media content; and
storing data for playing the second key event in the memory of the user device;
immediately subsequent to the user device playing the first key event, causing the user device to play the second key event based on the data for playing the second key event stored in the memory of the user device.

9. The method of claim 1, wherein the key event is a first key event, the method further comprising:
while the content feed item referencing the first key event is displayed:
identifying a second key event in the media content; and
storing data for playing the second key event in the memory of the user device;
subsequent to the user device playing the first key event, generating for display a user interface comprising an option to generate for display the second key event;
in response to a determination that the option for generating for display the second key event was not selected, deleting the data for playing the second key event stored in the memory of the user device.

10. The method of claim 1, wherein the media content playing via the content provider service comprises at least one of pre-recorded broadcast content, live broadcast content, or streaming content.

11. A system comprising:
control circuitry configured to:
identify an indication of user interest of a user for a media content playing via a content provider service;
monitor scrolling of a content feed on a user device associated with the user;
identify a key event in the media content;
based at least in part on the identifying the key event in the media content:
store data for playing the key event in a memory of the user device; and
modify the content feed, wherein the scrolling of the modified content feed causes the user device to display a content feed item referencing the key event, wherein a user interface interaction with the content feed item causes the user device to play the key event based on the data for playing the key event stored in the memory of the user device.

12. The system of claim 11, wherein the identifying the indication of user interest in the media content comprises at least one of: liking, pinning, saving, bookmarking, forwarding, sharing, posting, or archiving of additional content related to the media content.

13. The system of claim 11, wherein the system is configured, when identifying the indication of user interest in the media content, to analyze a user profile associated with the user to identify at least one keyword related to the media content.

14. The system of claim 11, wherein the system is configured when identifying the indication of user interest in the media content to determine that the media content is being generated for display on a media device located in proximity to the user device.

15. The system of claim 14, wherein the key event is a first event, and the content feed item is a first content feed item, and the system is further configured to:
identify a second key event in the media content;
based on determining that eye gaze of the user of the user device was directed to the user device when the second key event was played on the media device, modify the content feed on the user device to include a second content feed item referencing the second key event;
identify a third key event in the media content; and
based on determining that eye gaze of the user of the user device was directed to the media device when the third key event was played on the media device, refrain from modifying the content feed to include a third content feed item referencing the third key event.

16. The system of claim 11, wherein the system is further configured to:
subsequent to the user device playing the key event, generate for display a user interface comprising an option to generate for display a live stream of the media content, wherein a user interface interaction with the option causes the user device to play the live stream of the media content.

17. The system of claim 11, wherein the key event is a first key event, wherein the system is further configured to:
while the content feed item referencing the first key event is displayed:
identify a second key event in the media content; and
store data for playing the second key event in the memory of the user device; and
subsequent to the user device playing the first key event, generate for display a user interface comprising an option to generate for display the second key event, wherein a user interface interaction with the option causes the user device to play the second key event based on the data for playing the second key event stored in the memory of the user device.

18. The system of claim 11, wherein the key event is a first key event, the system is further configured to:
while the content feed item referencing the first key event is displayed:
identify a second key event in the media content; and
store data for playing the second key event in the memory of the user device;
immediately subsequent to the user device playing the first key event, cause the user device to play the second key event based on the data for playing the second key event stored in the memory of the user device.

19. The system of claim 11, wherein the key event is a first key event, the system is further configured to:
while the content feed item referencing the first key event is displayed:
identify a second key event in the media content; and
store data for playing the second key event in the memory of the user device;
subsequent to the user device playing the first key event, generate for display a user interface comprising an option to generate for display the second key event;
in response to a determination that the option for generating for display the second key event was not selected, delete the data for playing the second key event stored in the memory of the user device.

20. The system of claim 11, wherein the media content playing via the content provider service comprises at least one of pre-recorded broadcast content, live broadcast content, or streaming content.

21-50. (canceled)
